(19) United States
(12) Patent Application Publication
(10) Pub. No.: US 2011/0037766 A1
(43) Pub. Date: Feb. 17, 2011

(54) CLUSTER MAP DISPLAY

(75) Inventors: Scott A. Judy, Newnan, GA (US); Marsal Gavalda, Sandy Springs, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/857,746

(22) Filed: Aug. 17, 2010

Related U.S. Application Data
(60) Provisional application No. 61/234,423, filed on Aug. 17, 2009.

(51) Int. Cl. G06T 11/20; G06F 3/048

(52) U.S. Cl. 345/440; 715/771

(57) ABSTRACT

Systems and methods are providing for using cluster maps in managing multimedia content including, for example, analyzing audio files stored at a call center. Very generally, a cluster map can be used as an effective tool for visualizing condensed information and for improving the understanding of the characteristics and relationships of the data under study. For example, a set of nodes can be displayed in a cluster map as corresponding to a set of information objects. Each information object may represent the result of a respective query conducted against the data. In some embodiments, multiple relationships between various information objects (such as between different query results) can be displayed simultaneously as graphical links in the map, making data comparison and exploration easier and more intuitive.

### CROSS-REFERENCE TO RELATED APPLICATIONS

This application claims the benefit of U.S. application Ser. No. 61/234,423, filed Aug. 17, 2009, and entitled “Cluster Map Display” (Attorney Docket No. 30004-038P01), the contents of which are incorporated herein by reference.

### BACKGROUND

This description relates to information visualization systems, for example, systems that use cluster map for data representation.

Information visualization systems provide graphical tools for data representation that can be used to assist human understanding of the characteristics and relationships that exist within data. Such systems are particularly useful, for example, in presenting complex data that contains a large collection of content of various types and associations. By displaying information in a compact and organized form, for instance, using a tree-like structure to represent hierarchical relationships, some systems allow users to navigate rapidly through layers of content to identify and investigate targets of particular interest.

### SUMMARY

Some general aspects of the invention relate to systems and methods for managing multimedia content including, for example, analyzing audio files stored at a call center. Very generally, a cluster map can be used as an effective tool for visualizing condensed information and for improving the understanding of the characteristics and relationships of the data under study. For example, a set of nodes can be displayed in a cluster map as corresponding to a set of information objects. Each information object may represent the result of a respective query conducted against the data. In some embodiments, multiple relationships between various information objects (such as between different query results) can be displayed simultaneously as graphical links in the map, making data comparison and exploration easier and more intuitive.

In some examples, various metrics (e.g., various similarity measures) used in information retrieval can be applied to the query results to quantify and differentiate the relationships that exist in the data. This can help users to discover relationships of interest and to determine the direction of a follow-up search. This may further allow uses to validate the results of audio queries, for example, by checking their relatedness to other queries to see if they are behaving as expected.

Additional features of the systems and methods including scope-narrowing and the ability to perform quick searches provide a user-friendly interactive experience in speech analytics. For example, a user can compose and execute ad-hoc audio searches on the audio while displaying the cluster map. The results of the search can be displayed immediately, for example, as a new node in the map, and the relationships between those results and the existing query results can also be plotted. These ad-hoc searches can also be used as filters, allowing a user to interactively define and narrow the scope within which he wishes to investigate query relationships.

In some conventional information visualization systems, statistical data and charts are produced in batch mode after ingesting a group of audio files. The results may point to the need for more detailed follow-up queries in order to find the desired information in the data. The process of locating the desired information usually entails switching from reporting to another application, defining more queries, running the newly defined queries over the files, triggering the re-generation of reporting data, and opening a new reporting window to view the result. By contrast, the systems and methods described herein provide a way to conduct this process in one unified context. With immediate interactive graphical feedback from the ad-hoc search feature, the turnaround time for data analysis can be greatly reduced. The ad-hoc search feature also includes phonetically based search capability that allows for fast audio search with a phonetic index.

In some embodiments, an interactive filter building feature is provided such that one can filter on a logical combination (e.g., logical AND) of queries. This way, queries may be iteratively added to the filter and each successive view would be for a further reduced scope representing a more specifically defined subset of the files.

In general, in one aspect, the invention features a method for information visualization that includes receiving data characterizing a collection of multimedia content; processing the data to obtain a set of information objects, each information object being associated with a respective query on at least a portion of the collection of multimedia content; and generating a visual representation of characteristics of the set of information objects, including: displaying a plurality of graphical nodes, each graphical node representing a respective one of the information objects; determining, for each graphical node, a visual property based at least on a characteristic of the corresponding information object; displaying a plurality of graphical links between the nodes, each graphical link coupling a respective pair of graphical nodes and representing a relationship between the information objects represented by the pair of graphical nodes that are coupled by the link; and determining, for each link, a visual property based at least on a measure of the relationship represented by the link.

Embodiments of the invention may include one or more of the following features.

The method of generating the visual representation may further include obtaining the measure of the relationship between two information objects by computing a relatedness metric of the results of the queries associated with the two information objects. The relatedness metric may include one selected from the group of percent overlap, cosine similarity, Dice's coefficient, Jaccard Similarity, Hamming distance, and mutual information. The visual property for the graphical nodes may include one selected from the group of shape, size, and color. The visual property for the graphical links may include one selected from the group of shape, thickness, length, and color.

The method of generating the visual representation may further include determining a spatial order in which the plurality of graphical nodes is arranged. The method of forming the plurality of graphical links may further include selecting a graphical node of focus and displaying a respective graphical link coupling the node of focus with each one of the remaining nodes. The method of generating the visual representation may further include accepting a user input; and changing, for each node, the visual property based at least on the user input. The method of generating the graphical user interface may further include changing, for each link, the visual property based at least on the user input. The user input may include a new query. The method of generating the visual representation may further include processing the new query to generate a second set of information objects, each set of the second set of information object being associated with a satisfaction of a respective query and the new query.

The collection of multimedia content may include audio files. The data characterizing the collection of multimedia content may include a phonetic index of the audio files. The method of processing the data to obtain the set of information objects may include determining each information object based on a result of the respective query against the audio files. The method of determining each information object may include using a phonetically based search technique to identify audio files that match the respective query. The collection of multimedia content may include video files.

In general, in another aspect, the invention features a system for information visualization that includes a memory device for storing data characterizing a collection of multimedia content; an input device for accepting a user input; an output device for displaying a graphical user interface that includes a visual representation of characteristics of a set of information objects associated with the data, each information object being associated with a respective query on at least a portion of the collection of multimedia content; a processor coupled to the input device, the output device, and the memory device, the processor being configured for processing the user input and the stored data to control the graphical representation of the information objects displayed in the graphical user interface, including: displaying a plurality of graphical nodes, each graphical node representing a respective one of the information objects; determining, for each graphical node, a visual property based at least on a characteristic of the corresponding information object; displaying a plurality of graphical links between the graphical nodes, each graphical link coupling a respective pair of graphical nodes and representing a relationship between the information objects represented by the pair of graphical nodes that are coupled by the graphical link; and determining, for each graphical link, a visual property based at least on a measure of the relationship represented by the graphical link.

Embodiments of the invention may include one or more of the following features.

The processor may include a search tool configured for accepting one or more search terms inputted by the user and for performing a respective query on the multimedia content according to each search term. The search tool may be further configured to use a phonetically based search technique to perform the query.

The processor may further include a vector generator configured for generating a set of bit vectors each representing a respective query result. At least one bit vector may include N number of binary bits, N being the number of files on which the query is performed.

The processor may include a mode selector configured for forming a specification of a set of display properties in response to a user selection. The set of display properties may include a partially defined spatial arrangement for the plurality of nodes. The set of display properties may include a partially defined color coding for the nodes and links.

The processor may further include a display filter configured for filtering query results based on a user-defined criterion. For each node, the node property may represent the volume of a subgroup of multimedia content that satisfies the query. For each link, the link property may represent a similarity measure of the query results associated with the two nodes connected by the link.

Other features and advantages of the invention are apparent from the following description, and from the claims.

### BRIEF DESCRIPTION OF DRAWINGS

FIG. 1 shows one embodiment of a cluster map.

FIG. 2 shows an exemplary cluster map for displaying audio queries processed at a call center.

FIG. 3 is a block diagram of an exemplary system for generating the cluster map of FIG. 2.

FIG. 4 is a flow chart of one procedure for generating the cluster map of FIG. 2.

FIG. 5A shows an exemplary GUI for user-interactive display of cluster map.

FIG. 5B shows an exemplary procedure for user-interactive display of cluster map.

FIG. 6 shows an exemplary cluster map in “Global Display” mode.

FIG. 7 shows an exemplary cluster map in “Set-Centric Display” mode.

FIG. 8 shows an exemplary cluster map in “Normalized Display” mode.

FIG. 9 shows an exemplary cluster map in “Non-normalized Display” mode.

FIG. 10 shows an exemplary cluster map in “Node Detail Display” mode.

FIG. 11 shows an exemplary cluster map in “Link Detail Display” mode.

FIG. 12 shows an exemplary cluster map in “Filtered Display” mode.

FIG. 13 shows an exemplary cluster map in “Node Sorting Order” mode.

FIG. 14 shows a way for measuring relatedness between two sets of files.

FIG. 15 shows an exemplary cluster map using non-weighted mutual information measure.

FIG. 16 shows an exemplary cluster map using weighted mutual information measure.

### DETAILED DESCRIPTION

### 1 Overview

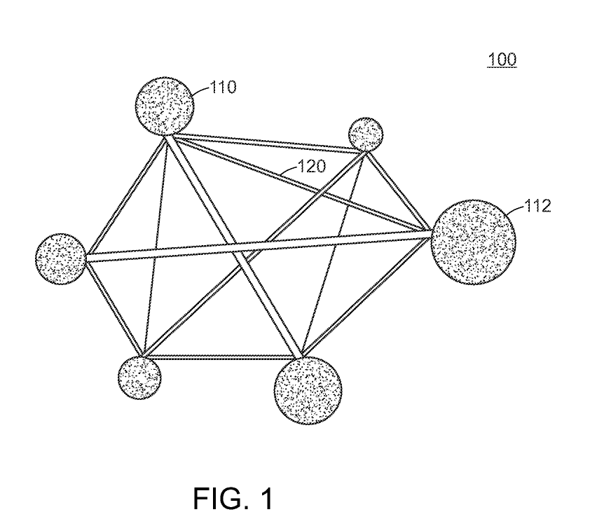

FIG. 1 shows one embodiment of a cluster map 100 for data representation. In this embodiment, the cluster map 100 uses at least two classes of graphical objects, i.e., nodes (e.g., node 110) and links (e.g., link 120), to represent various characteristics and relationships of the data being displayed. More specifically, a node represents a classification of data that, in some examples, may correspond to a single piece of item or a collection of items that share a common characteristic. A link represents a type of relationship between the data represented by the pair of nodes to which the link is connected. Examples of relationships that can be represented in the map include, for example, item similarities, parent-child associations, and temporal and spatial relationships.

In some examples, each node and/or link may be embodied in selected shape (e.g., circular or rectangular, 2D or 3D), size, color (e.g., grey-scale or RGB), and/or other visual properties (e.g., color fill pattern) such that various aspects of the data can be revealed simultaneously by a single object. Some nodes/links may also be configured to include textual information for displaying further details of the data as desired.

The cluster map 100 shown above can be useful in visualizing clustered data that includes a wide variety of types of information. It can also capture multiple types of relationships that may exist among information of similar or disparate kinds. Such a visual tool enables users to identify and investigate interesting relationships in large and complex information collections and to perform a multitude of analyses of the information concurrently.

One application of the cluster map relates to managing multimedia content, including for example, managing an archive of audio inquiries received at a call center. A call center handles customer inquires, many of which are subsequently saved to the archive in the form of audio files. The archive itself may be partitioned into several “sessions,” each of which refers to a general categorization of audio files such as “technical support,” “sales,” and “agent response.” Each session may include a large number of audio files that may be further grouped into sub-sessions. For each new audio file that is included in (or otherwise stored in association with) the archive, a set of “queries” (e.g., search terms) may be run against the audio (e.g., using a text-based or phonetically based search technique) to help determine, for example, the contents and the destination of the file. Examples of queries include “change of address,” “balance transfer,” “late fees,” and “cash advance.” The “hits” generated by this query process are stored in a database for further analysis. In one example, the results of the query process are indicative of which queries “hit” on which audio files in which session for how many times. As the archive expands, the increasing number of audio files, queries and sessions can lead to the growing complexity in managing and displaying the vast amount of information contained in the entire archive. It may also become more difficult for extracting interesting data and for finding correlations of data even when all of the information needed for analysis is present in the archive.

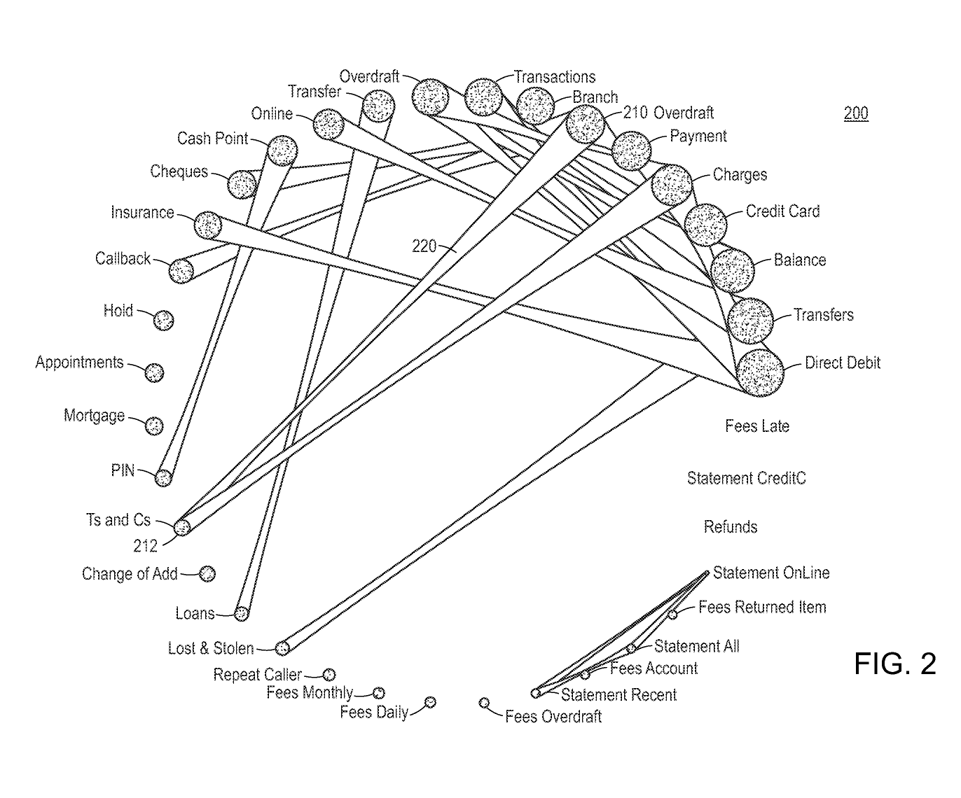

FIG. 2 shows one example of a cluster map 200 configured for displaying a portion (or portions) of the archive of audio files described above. In this example, the map 200 includes a number of circular nodes (e.g., node 210) that together represent the group of queries in display. For instance, node 210 represents query “Overdraft,” and the size of the circle indicates the number of audio file in the archive (or in a particular session of the archive) for which the query has hits. Each node may be connected to one or more other nodes in the map by a corresponding link that indicates a degree of node relatedness or similarity. For instance, nodes 210 and 212 are coupled by link 220 whose line thickness and/or length is determined based on a measure of relationship between the two queries “Overdraft” and “Ts and Cs.” In some examples, the measure of relationship may be obtained by a similarity metric that characterizes a specific aspect of the pair-wise relationship, for example, the percentage of audio files matching both queries among the pool of files that satisfies at least one query. Various embodiments of the similarity metric and ways of metric computation will be described in greater detail later.

The cluster map 200 provides a visually intuitive way of understanding the characteristics of the queries that generate hits, and further, of understanding the relationships between queries to help, for example, obtain actionable business intelligence. For instance, multiple pair-wise relationships can be viewed at once and compared with one other to determine, for example, whether the queries for “escalations to a manager” at a call center occur more often with a particular product, agent, or procedure than with another. In some examples, the interpretability of the map 200 can also be enhanced by applying various color- or shape-encoding techniques to the nodes/lines (e.g., using various color ranges to indicate the average lengths of the calls matching a particular query) and by placing textual information in association with the nodes/links (e.g., describing the volume of the audio files on which a query was performed). Additional search tools and filtering tools may also be used to enable advanced functionalities as will be described later.

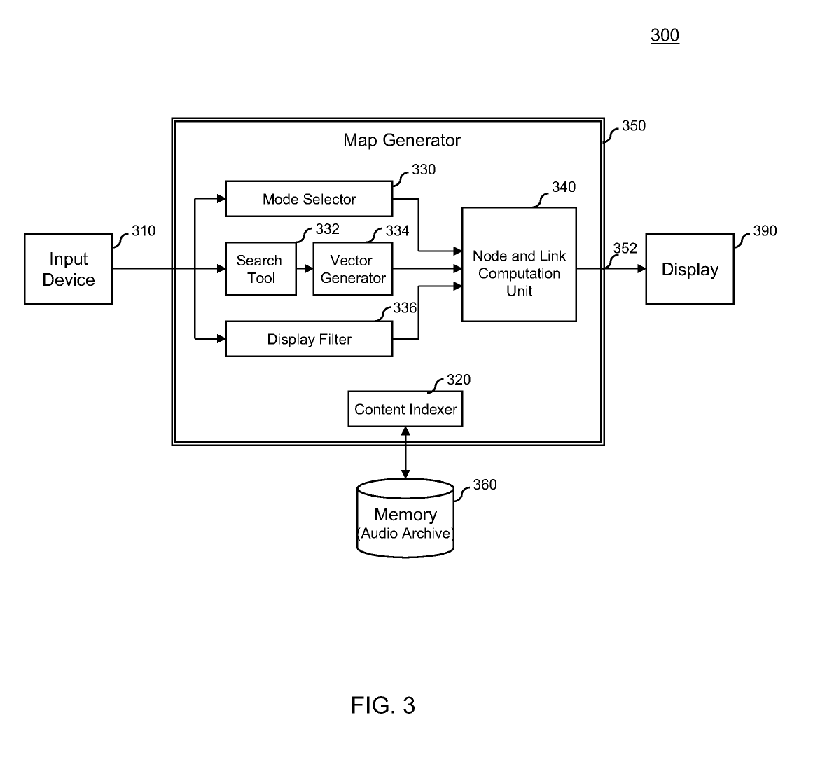

FIG. 3 shows a block diagram of an exemplary system 300 for generating the cluster map 200 shown in FIG. 2. The system 300 includes an input device 310 (e.g., a keyboard, mouse and/or keypad) for receiving user input, a memory 360 for storing data (including the audio archive), a map generator 350 (e.g., a processor) for generating a cluster map 352 according to the user input and the data, and a display unit 390 (e.g., a monitor) for displaying the cluster map. More specifically, the map generator 350 makes use of a content indexer 320 that communicates with the memory 360 to index the audio files in the archive and to retrieve relevant data for display (e.g., information on the audio files, including for example, “hits” of the files and data length).

In some implementations, the map generator 350 includes a set of processing components (e.g., logical circuits) that are responsive to user input individually and/or collaboratively. These components include a mode selector 330 configured for executing a selected mode of display (e.g., global versus set-centric), a search tool 332 for allowing users to perform both global and local searches while displaying the cluster map, and a display filter 336 for filtering search results based on user-defined filtering criterions. Outputs of these components are provided to a node and link computation unit 340, which then computes the size and/or color of each node to be displayed, and the size and/or color of the links between the nodes. The specific implementations and functionalities of these components of the map generator 350 are further described below.

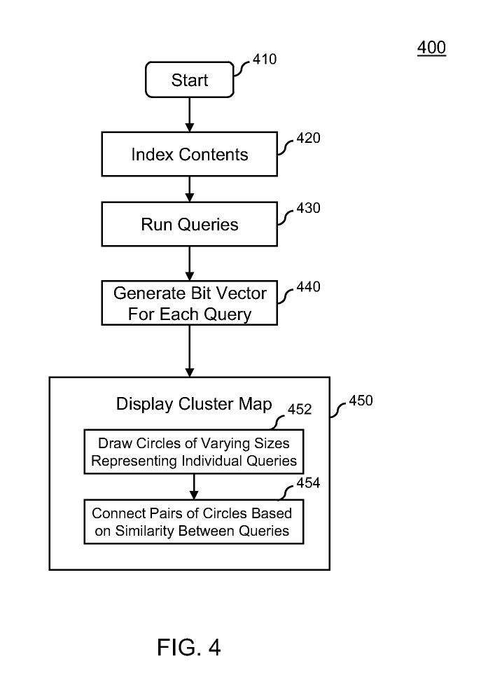

FIG. 4 shows an exemplary procedure of the map generator 350 for generating the cluster map 200 of FIG. 2.

Initially, at step 420, the content indexer 320 accesses the audio archive in the memory 360 and maintains a dynamic index of the archive, for example, for later retrieval of a specific file or a segment of the file. In some examples, the content indexer 320 also provides a way to upload the results of distributed processing of content (e.g., collaborative tagging) to index queries that have been found present in the audio, thereby accelerating the subsequent retrieval by the same queries. For example, when different users search for terms in an audio, the identified segments that include the terms are kept track of, for example in the dynamic index, to aid later users in finding or browsing the audio.

At step 430, the search tool 332 receives a list of queries that the user desires to view in the map (or otherwise the queries by default) and performs searches to identify the audio files that contains the queries. In some examples, the search tool 332 first checks the dynamic index to see whether some or all of the queries have been previously processed and if so, proceeds directly to locate the audio files that contains hits using information in the dynamic index. In the event that one or more of the queries is new, the search tool 332 runs the new query through the archive, for example, using text-based and/or phonetically based word-spotting techniques, to identify the presence of the query in the audio files and also to compute the cumulative hits of the query during the search.

At step 440, once the query search completes, a vector generator 334 generates a bit vector for each query. In some examples, a bit vector is defined as a vector containing N number of bits, where N is the number of files on which the query is conducted and each bit may be a 0 (meaning the query did not hit a particular file) or 1 (meaning that the query hit the file). In some other examples, each bit may represent the number of hits for a query (rather than merely a hit/miss decision).

At step 450, the output of the vector generator 334 is provided to the node and link computation unit 340, which then determines the properties of the nodes and links for generating an initial cluster map. More specifically, a set of circles are first drawn to represent the group of queries that the user desires to view and a set of links are subsequently plotted between pairs of the circles to represent query relationships.

In some examples, the size of a circle is computed based on the query results, for instance, in direct proportion to the number of files matching the query. Thus, a larger circle indicates a larger set of files. In some examples, the sizes of the circles are normalized such that the query with the most results will always appear in a circle of a predetermined size while all of the other circles are properly scaled. Optionally, the number of files in a particular node can also be displayed in a map by hovering over the node.

In some examples, the link between a pair of circles indicates a degree of relatedness between the corresponding queries, which may be defined using one of several different measures described in a later section. The length and width of a link can be computed using the same measure, or alternative, be defined separately to allow different aspects of the relationship be revealed concurrently. The color of a link may also be used to differentiate relationships of distinct characteristics, for example, to differentiate a “negative” relationship using a base color of red from a “positive” relationship using a base color of black. Examples of “negative” and “positive” relationships are also provided in a later section.

In some implementations, the cluster map generated by the map generator 350 is provided to users through a graphical user interface (GUI) that allows for data viewing and analyzing in a number of interactive ways including, for example, performing ad-hoc searches, redefining scope of data, and selecting displaying modes, as described below.

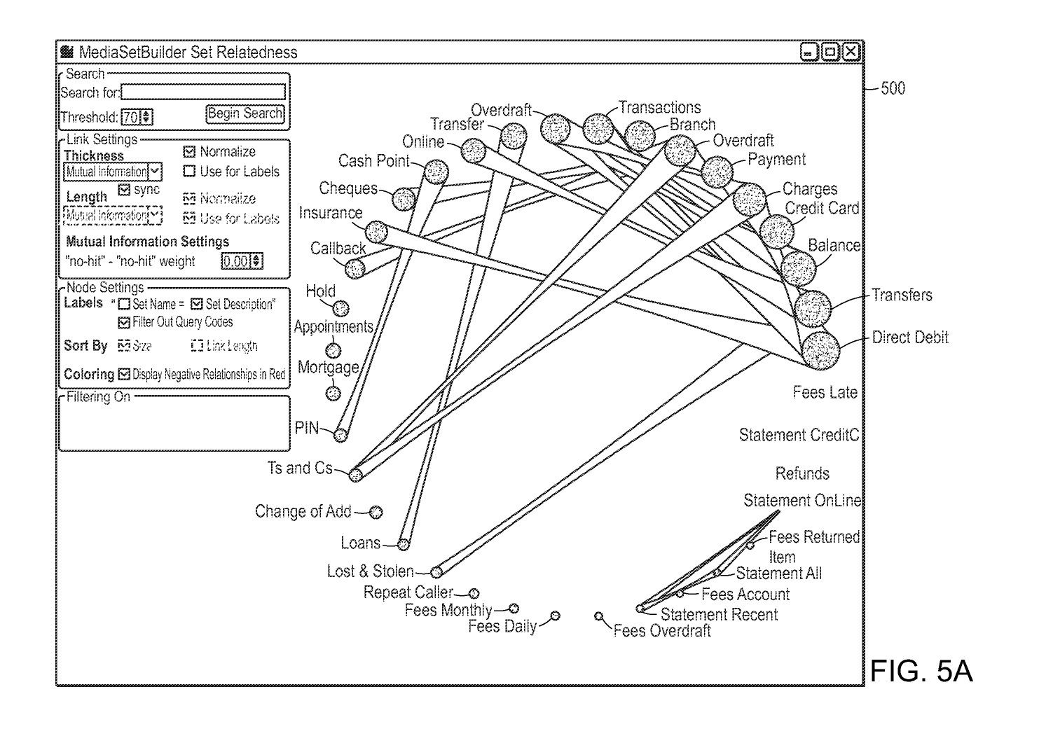

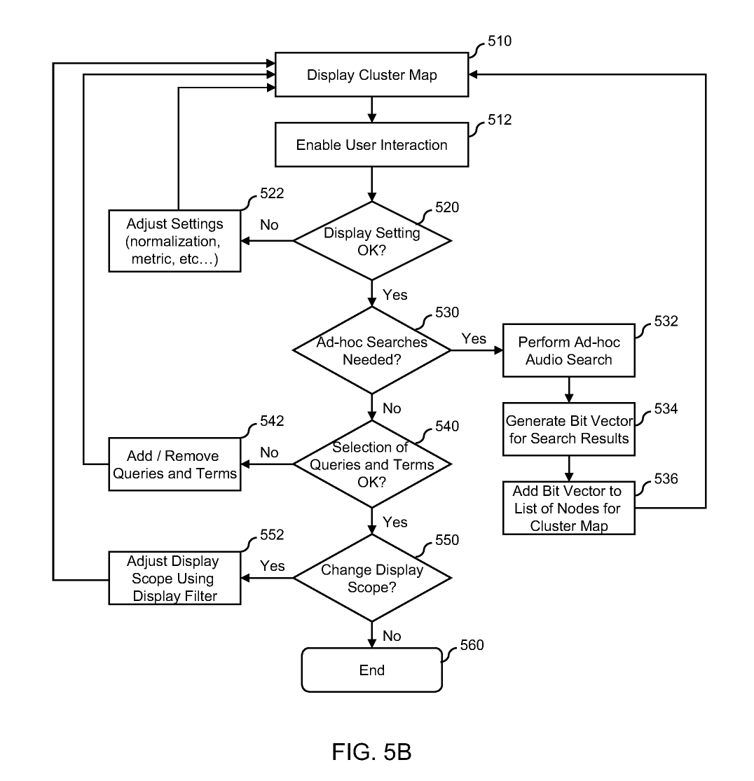

FIG. 5A shows an exemplary GUI for user-interactive display of cluster map and FIG. 5B shows an exemplary procedure for use with the GUI of FIG. 5A.

At steps 510 and 512, the cluster map generated by procedure 400 is conveyed to the user through GUI 500, which enables user control and navigation.

At step 520, the user reviews the cluster map in display and determines whether any changes to the display settings are desired. Here, user-adjustable display settings include without limitation node settings (such as node size, node location, node color, and co-display of query name and/or query description with nodes) and link settings (such as link width, link length, link color, and co-display of link labels). Also, a user may select to have all nodes shown in a concentric manner to review all pair-wise relationships or alternatively, to focus on one particular node of interest and review only relationships that involve this node. At step 522, upon receipt of user input, the map generator 350 instructs the node and link computation unit 340 to re-compute display parameters and subsequently generates an updated cluster map for display. In some examples, a set of display modes may be pre-defined and the corresponding settings are stored in the memory for convenient selection by user through the mode selector 330. Examples of pre-defined display modes are described in a later section.

At step 530, the user can select to compose and execute ad-hoc searches on the audio files while displaying the cluster map. For example, the user may first define the scope of the search (e.g., the, entire audio archive or a session of the archive) and then performs audio searches (e.g., using a text-based and/or a phonetically based search technique) on the defined scope to locate subjects of interest. In some examples, by inputting one or more key terms (either through text input or audio input), the user searches in the a text source associated with the audio archive (e.g., content tags, phonetic indexes, or other text-based sources from which tags or indexes may be derived) to find audio files or segments of the files that correspond to the key terms. At step 534, a new bit vector is generated for the results of that search. At step 536, using the new bit vector, the search results can be displayed immediately as a new node in the cluster map, and the relationships between the new node and the existing nodes can also be plotted.

At step 540, after reviewing the nodes in the cluster map, the user is also able to remove existing query nodes (e.g., queries of weak correlation to a selected subject of investigation) from the map and to add new queries (e.g., undisplayed queries that nonetheless have strong correlation to the subject of investigation). This allows the user to zoom in on a subset of files in which further attention is needed and also allows him to build consolidated maps efficiently by incorporating his prior knowledge or expertise in the area.

At step 550, the user can also use the GUI 500 to change the scope of display. A display filter may be provided to users, for example, for narrowing the query results to only the results that satisfy a specific filter entry. For instance, upon receiving filter entry “Overdrawn”, the map generator re-computes the nodes and links such that an updated node such as “Payment” would now only include files that matches both query “Payment” and filter entry “Overdrawn.” In other words, all the previous query results are adjusted to a narrowed set of files that should at least match “Overdrawn.”

Note that these interactive functionalities shown in FIG. 5B may not be necessarily performed in the chronological order described above. In practice, the user may elect to use one or a combination of the functions in any desired order to facilitate data navigation and analysis.

In addition, the user may also use the mode selector 330 for displaying the cluster map in one or more of a set of pre-defined modes. Each display mode may be associated with a corresponding set of pre-defined display properties, which can be stored in the system as configuration data for later access. Examples of pre-defined display properties include partially-defined spatial arrangement for nodes (e.g., global vs. set-centric), and color and/or size coding for nodes and/or links, as will be described in detail below.

### 2 Display Modes

Depending on implementation, there are various ways of displaying the cluster map, some of which are illustrated below.

### 2.1 Global Display

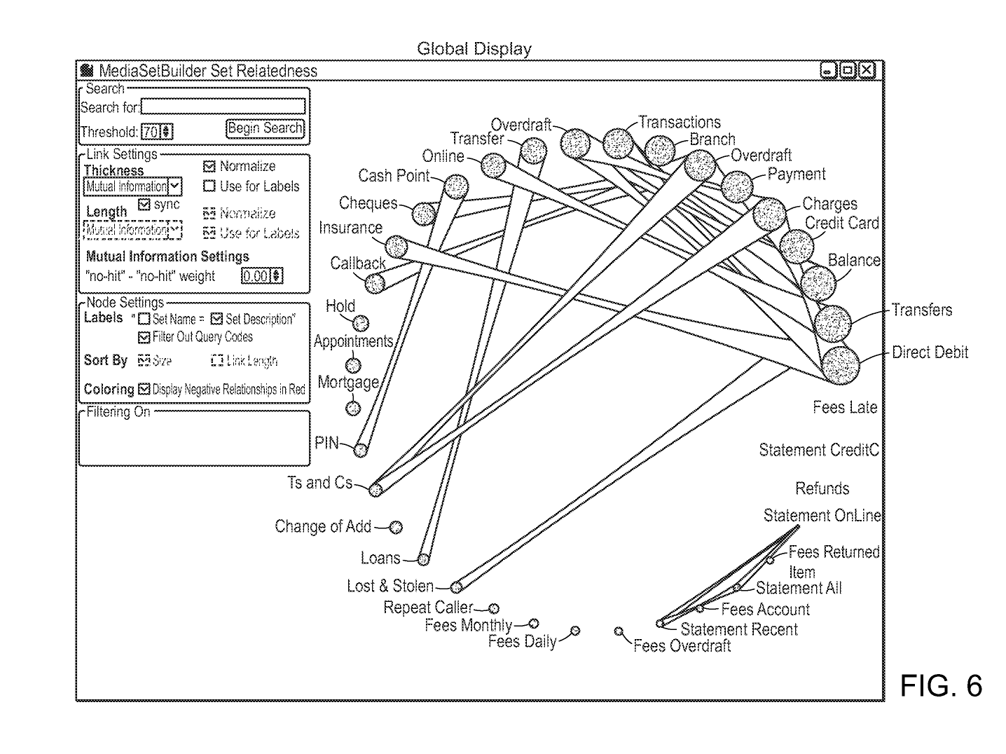

FIG. 6 shows an example of a global display, in which all of the two-way relationships between selected queries are plotted. In this example, the circular nodes (e.g., colored in green) represent queries searched on a common set of audio files. The size of each node represents the number of hits of the corresponding query. The links (e.g., shown in black or gray lines) between the nodes represent the strength of the two-way relationship between the queries. In this particular example, the nodes are arranged in a ring and ordered according to ascending node sizes in a clockwise fashion. Depending on viewer preferences, in other examples, the nodes can also be arranged in alternative manners.

### 2.2 Set-Centric Display

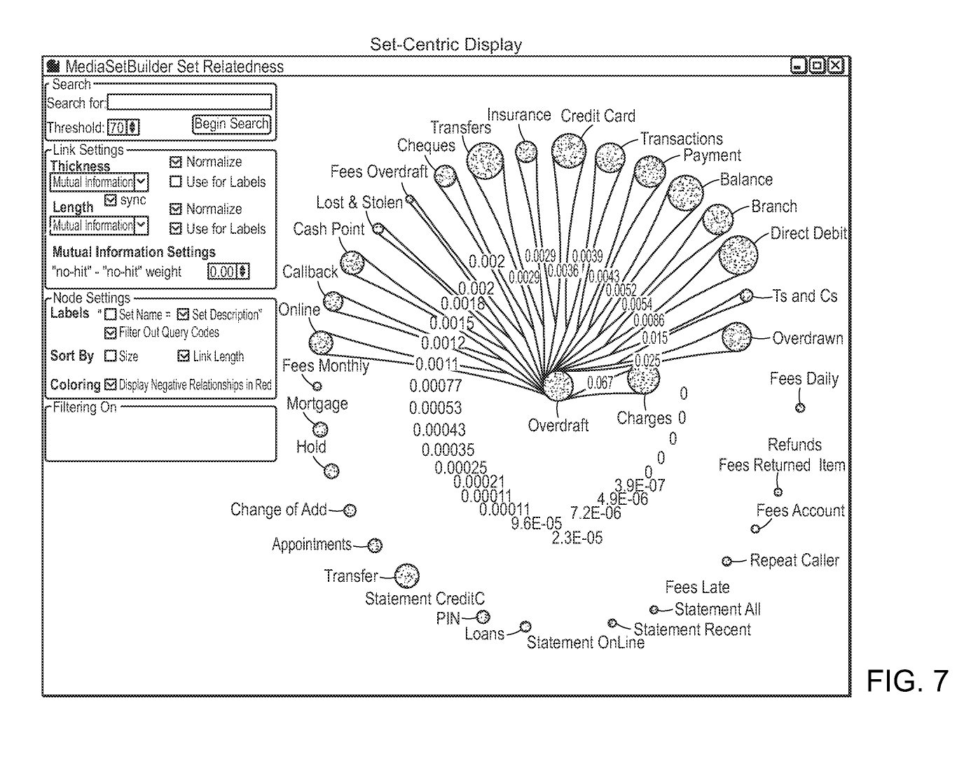

FIG. 7 shows an example of a set-centric display, in which one query is made the focus of the display and the relationships of each of the other queries to that query is shown. In this example, query “Overdraft” is made the focus of the display. All of the other queries are plotted in the map radially adjacent to the node of “Overdraft.” Here, it is possible to use not only the width and the darkness of the link, but also the distance between the query nodes, to represent aspects of the relationship between the queries. This way, the length of the link reinforces the strength of the relationship that is also shown in the width of the link. Note also that the links are labeled with the actual numerical score corresponding to a similarity metric computed as a measure of each relationship.

### 2.3 Normalized Display

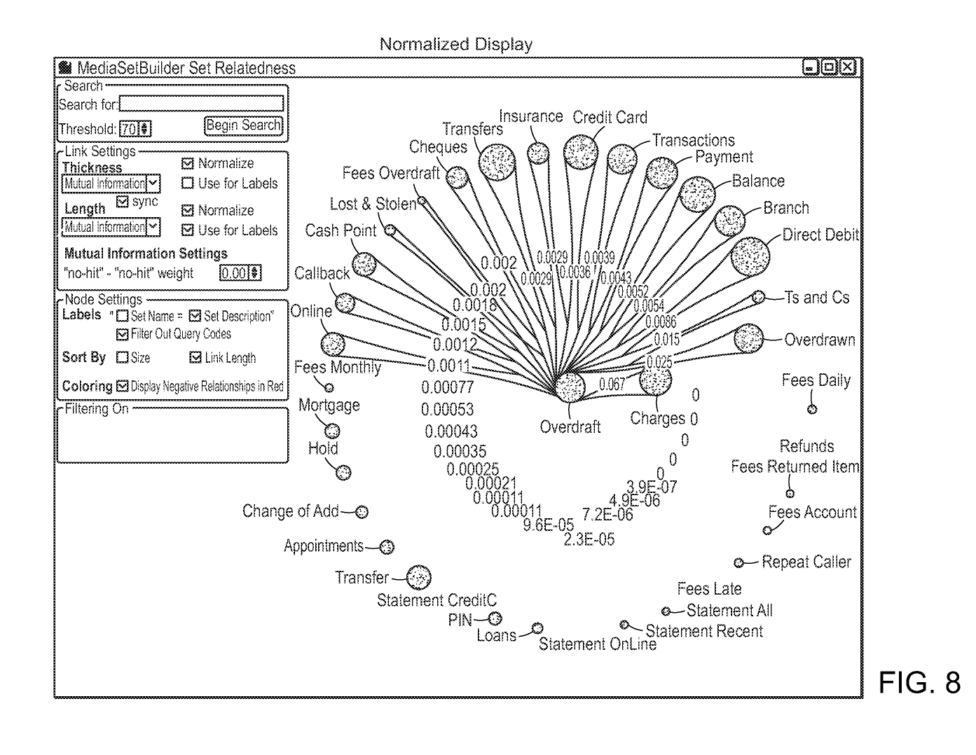

FIG. 8 shows an example of a normalized display, in which the links are normalized in at least one aspect (e.g., length, width, and/or darkness) according to the maximum and minimum numerical scores of the relationships displayed in the map. For example, the link for which the relationship is the strongest is plotted at the minimum length (or maximum width) and the link for which the relationship is the weakest is plotted at the maximum length (or minimum width) the graph can display. All other links are properly scaled in size according to the two extremes.

### 2.4 Non-Normalized (Absolute) Display

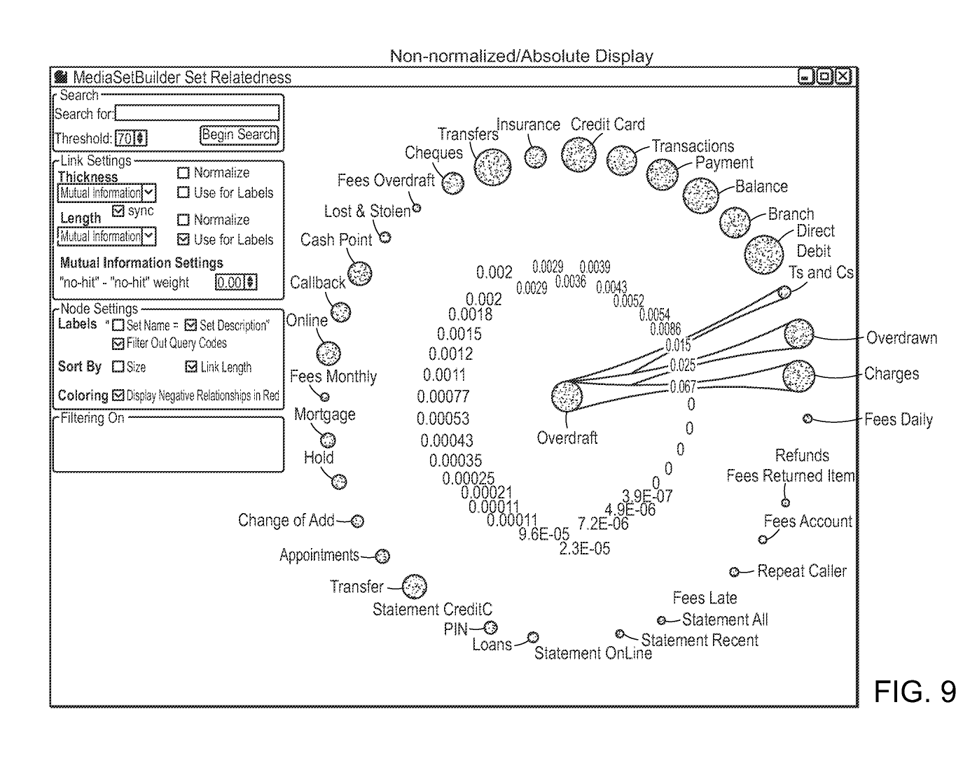

FIG. 9 shows an example of a non-normalized display, in which the minimum possible graphical length and/or maximum possible width/darkness of the link corresponds to the maximum possible value (also referred to as an absolute maximum value) for a similarity metric on any two queries. Similarly, the maximum possible graphical length and/or minimum possible width/darkness of the link corresponds to an absolute minimum value. In other words, the link widths and the distances between any two nodes remain unchanged regardless of which set of queries are selected for display. For a given display, the full range of possible link lengths/widths may not necessarily be used.

### 2.5 Detailed Display

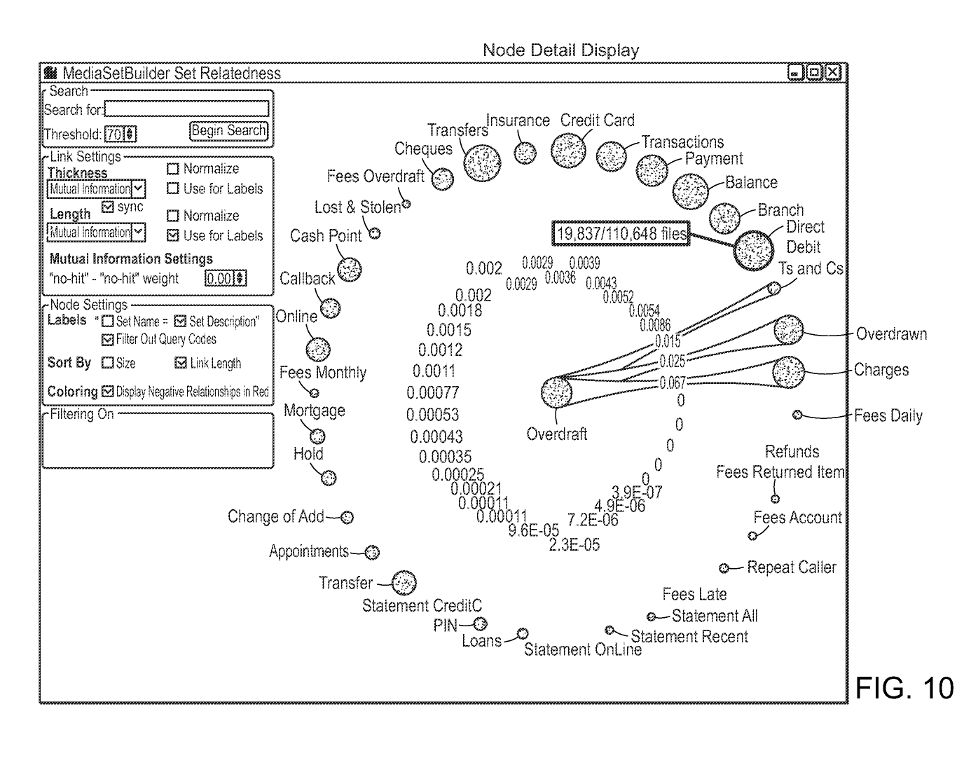

FIG. 10 shows an example of a detailed display, in which detailed information of individual nodes may be conveyed to users, for example, upon user activation. For instance, when a user wants to learn more about a particular query such as “Direct Debit,” he can move the mouse over the area of the corresponding node or click on the node, which prompts a pop-up window indicating, for example, statistics of the search results. In this example, it is shown that the number of files matching the “Direct Debit” query is 19,837 out of a set of 110,648 files on which all of the queries were run.

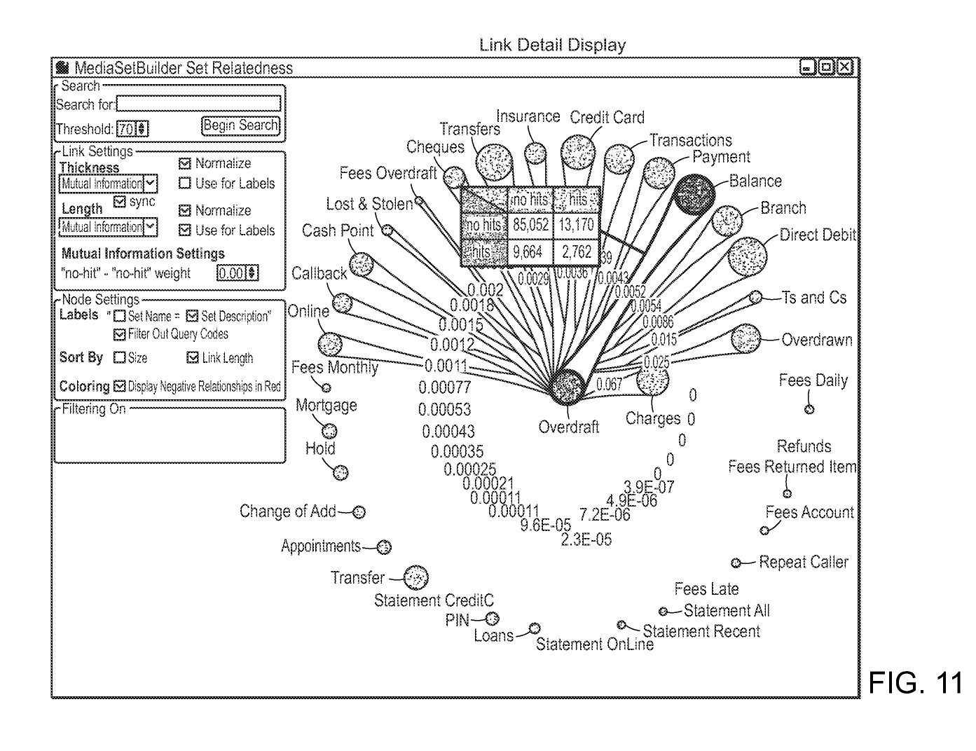

FIG. 11 shows another example of a detailed display, in which detailed information of individual links may also be conveyed to users. For instance, letting the mouse hover over a link causes a pop-up window with statistics about the relationship to be display. In this example, the pop-up window for the link between query “Balance” and query “Overdraft” shows that 85,052 files matched neither of the two queries, 2,765 matched both queries, 9,664 matched “Balance” but not “Overdraft,” and 13,170 matched “Overdraft” but not “Balance.”

### 2.6 Filtered Display

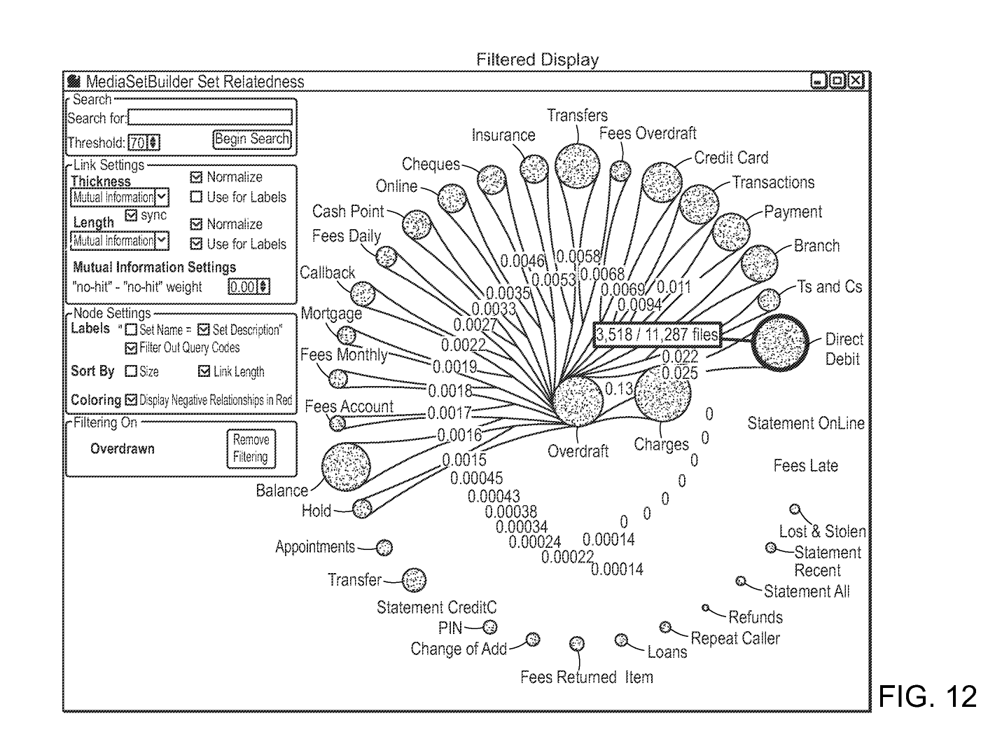

FIG. 12 shows an example of a filtered display, in which the search scope can be narrowed, for example, by defining one set of query results to be the scope of the display such that all of the query results to be displayed and the relationships between the queries are filtered on that particular query. In this example, a filter query “Overdrawn” (different from “Overdraft”) is entered and indicated at the end of the left column. The background of the map is shaded green. The selected similarity metrics are also re-calculated within the filtered space. For example, in FIG. 12, the scope of the search is now limited to the 11,287 files that match the “Overdrawn” query, i.e., a subset of the entire pool of 110,648 files. The pop-up window for node “Direct Debit” now indicates that 3,518 files out of the subset of 11,287 files also matched the “Direct Debit” query.

For the purpose of comparison, the unfiltered node detail display in FIG. 10 shows that a total of 19,837 files in the entire archive actually match the “Direct Debit” query. The count of 3,518 files for the same query in the filtered view of FIG. 12 is a result of setting the “Overdrawn” query as the filter to change the scope of display.

### 2.7 Other Displays

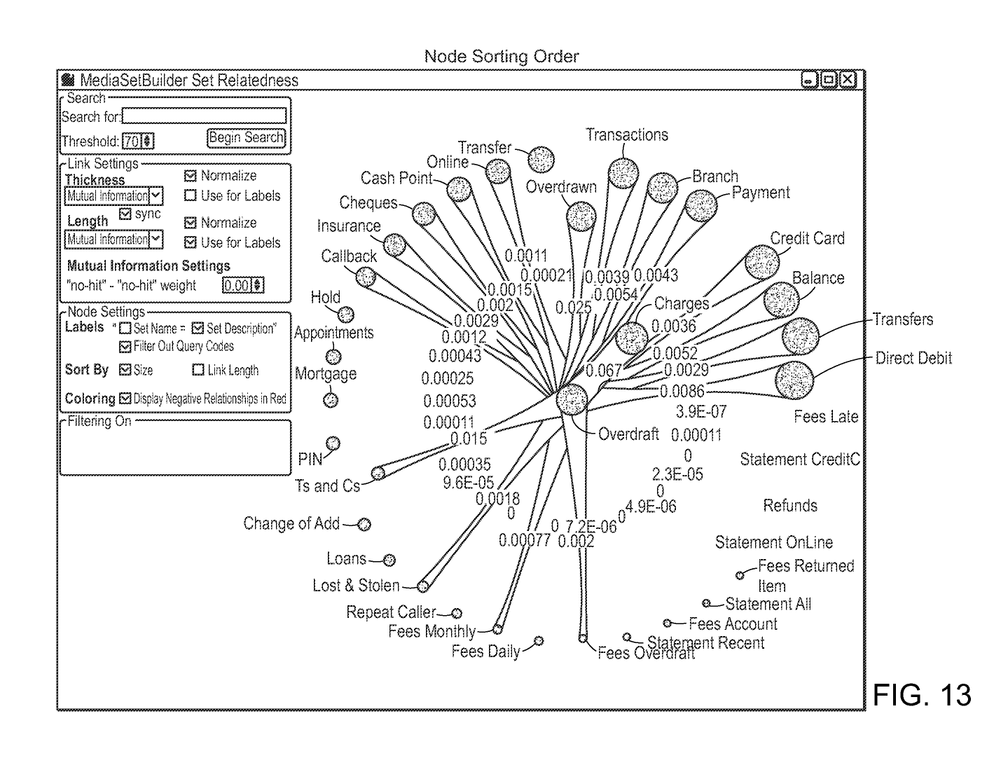

In addition to the aforementioned display modes, other options are also available. For example, the order by which the query nodes are arranged may be configured according to the strength of the link (as shown in FIG. 7), or alternatively, based on node size (e.g., the volume of the query results) as illustrated in FIG. 13. The color of the nodes and/or links can also be defined to enhance contrast between objects of different characteristics, for example, large versus small query results and strong versus weak relationships.

### 3 Similarity Metrics

As previously discussed, a link in the cluster map 200 can be used to represent a type of relationship between the data that are represented by the pair of nodes coupled by the link. In some examples, the relationship is embodied as a degree of node relatedness or similarity, which can be measured by one of several similarity metrics that each examines a different aspect of the relationship. The following description provides some examples of similarity metrics that can be implemented in the cluster map described herein.

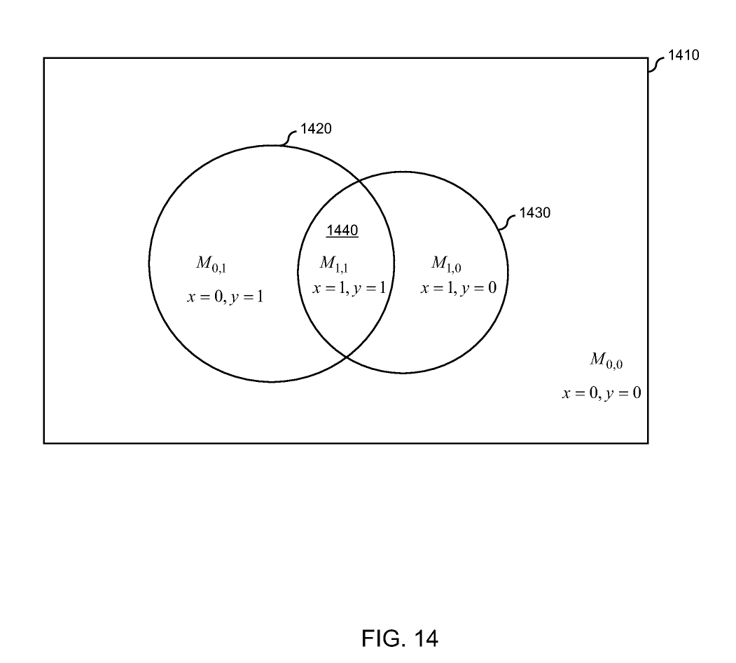

Referring to FIG. 14, to help understand various similarity metrics and the differences between them, it is useful to first assume that, in a set of N number of audio files, there are two overlapping subsets of files that match queries X and Y, respectively. For illustrative purposes, in this figure, a rectangular area 1410 represents the total N number of files on which queries are conducted. A first circle 1420 represents a subset of files for which query Y matches, and a second circle 1430 represents another subset of files for which query X matches. The overlap 1440 between the two circles, also referred to as M_{1,1}, corresponds to the set of files that match both queries X and Y. Accordingly, region M_{0,1} (i.e., circle 1420 subtracted by overlap 1440) corresponds to the set of files that match query Y but not query X, and region M_{1,0} (i.e., circle 1430 subtracted by overlap 1440) corresponds to the set of files that match query X but not query Y. Region M_{0,0} corresponds to the set of files that match neither X nor Y. The total number N of files in the entire set satisfies the following:

N=|M_{0,0}|+|M_{0,1}|+|M_{1,0}|+|M_{1,1}| (1)

Given the above assumption, several different similarity measures are illustrated below.

### 3.1 Percent Overlap

One similarity measure computes percent overlap, which is given by:

$$\begin{matrix}PO ( X , Y ) = \frac{\vert {M}_{1 , 1} \vert}{\vert {M}_{1 , 0} \vert + \vert {M}_{1 , 1} \vert} \\ and & ( 2 ) \\ PO ( Y , X ) = \frac{\vert {M}_{1 , 1} \vert}{\vert {M}_{0 , 1} \vert + \vert {M}_{1 , 1} \vert} & ( 3 )\end{matrix}$$

Here, the values of PO(X,Y) and PO(Y,X) are not necessarily equal due to the difference in denominators. Therefore, this metric is non-symmetrical and can be used to describe a two-way relationship in both directions. This percent overlap is usually not implemented in the “Global Display” mode, which makes no distinction between the ordering of the two sets being compared. When implemented in the “Set-Centric Display” mode where one node is made the focus of the map, the links between other nodes with this central node are computed in a consistent manner either using equation (2) or equation (3).

### 3.2 Cosine Similarity

A second similarity measure computes cosine similarity, which is a vector-based metric obtain by:

$$CS ( X , Y ) = \frac{\vert {M}_{1 , 1} \vert}{\sqrt{\vert {M}_{0 , 1} \vert + \vert {M}_{1 , 1} \vert} \sqrt{\vert {M}_{1 , 0} \vert + \vert {M}_{1 , 1} \vert}} \qquad ( 4 )$$

Because of the symmetry of this metric, i.e., CS(X,Y)=CS(Y,X), it can be implemented in all modes, including both “Global Display” mode and “Set-Centric Display” mode.

### 3.3 Dice's Coefficient

A third similarity measure computes Dice's coefficient, which is given by:

$$DC ( X , Y ) = \frac{2 \vert {M}_{1 , 1} \vert}{\vert {M}_{0 , 1} \vert + 2 \vert {M}_{1 , 1} \vert + \vert {M}_{1 , 0} \vert} \qquad ( 5 )$$

This is also a symmetric measure that can be implemented in all display modes.

### 3.4 Jaccard Similarity

A fourth similarity measure computes Jaccard Similarity, which is given by:

$$JS ( X , Y ) = \frac{\vert {M}_{1 , 1} \vert}{\vert {M}_{0 , 1} \vert + \vert {M}_{1 , 0} \vert + \vert {M}_{1 , 1} \vert} \qquad ( 6 )$$

This is also a symmetric measure that can be implemented in all display modes.

### 3.5 Hamming Distance

A fifth similarity measure computes Hamming distance, which is given by

$$HD ( X , Y ) = \frac{\vert {M}_{0 , 1} \vert + \vert {M}_{1 , 0} \vert}{N} \qquad ( 7 )$$

This Hamming distance is essentially the percentage of files for which exactly one query matches. It is also a symmetrical measure.
In some examples, the Hamming distance may be defined alternatively as the remaining percentage of files, given by

$$HS ( X , Y ) = 1 - HD ( X , Y ) = \frac{\vert {M}_{0 , 0} \vert + \vert {M}_{1 , 1} \vert}{N} \qquad ( 8 )$$

which provides the percentage of files for which the results of the two queries are the same (either “hit” both or “miss”).

### 3.6 Mutual Information

A sixth similarity measure uses a customized version of information-theoretic “mutual information” metric, given by

$$I ( X , Y ) = {\sum }_{x ∈ X , y ∈ Y} p ( x , y ) {log}_{2} \frac{p ( x , y )}{p ( x ) p ( y )} \qquad ( 9 )$$

Here, for cluster map applications, random variables X and Y can be defined as X∈{0,1} and Y∈{0,1}, respectively, where a value of 0 corresponds to a file not matching a query, and a value of 1 corresponds to a match. A bit vector is defined as a vector of query results. The vector length is equal to the number of files (N) being searched, and each bit position in the vector indicates a hit (i.e., 1) or a miss (i.e., 0) for a particular file. Each bit position is treated as a random trial.

Rewriting equation (9) in terms of the above definition yields:

$$I ( X , Y ) = p ( x = 0 , y = 0 ) {log}_{2} \frac{p ( x = 0 , y = 0 )}{p ( x = 0 ) p ( y = 0 )} + p ( x = 0 , y = 1 ) {log}_{2} \frac{p ( x = 0 , y = 1 )}{p ( x = 0 ) p ( y = 1 )} + p ( x = 1 , y = 0 ) {log}_{2} \frac{p ( x = 1 , y = 0 )}{p ( x = 1 ) p ( y = 0 )} + p ( x = 1 , y = 1 ) {log}_{2} \frac{p ( x = 1 , y = 1 )}{p ( x = 1 ) p ( y = 1 )} \qquad ( 10 )$$

Further rewriting equation (10) by replacing probability variable p with file counts C yields

$$I ( X , Y ) = \frac{C ( x = 0 , y = 0 )}{N} {log}_{2} \frac{C ( x = 0 , y = 0 ) N}{C ( x = 0 ) C ( y = 0 )} + \frac{C ( x = 0 , y = 1 )}{N} {log}_{2} \frac{C ( x = 0 , y = 1 ) N}{C ( x = 0 ) C ( y = 1 )} + \frac{C ( x = 1 , y = 0 )}{N} {log}_{2} \frac{C ( x = 1 , y = 0 ) N}{C ( x = 1 ) C ( y = 0 )} + \frac{C ( x = 1 , y = 1 )}{N} {log}_{2} \frac{C ( x = 1 , y = 1 ) N}{C ( x = 1 ) C ( y = 1 )} \qquad ( 11 )$$

where N is the number of trials (i.e., the number of bits in the bit vector or files searched), and C(x=0, y=1), for example, is the count of trials in which x=0 and y=1 (i.e., query X does not match but query Y does).

Note that the trial result counts are equivalent to the number of files in sets previously defined. For example, C(x=0, y=1) is the same as M_{0,1} as used in other metrics defined in this specification.

### 3.6.1 Weighting of Positive and Negative Matches

In the conventional measure of mutual information, all combinations of hit and miss for the two queries on a file are usually given equal weights in terms of relateness. In practice, it may be desirable to treat both queries hitting on a file as stronger evidence of relatedness than both queries missing for a file. The metric can thus be amended to accommodate this observation by adding weight coefficients w(x, y) in equation (9), as shown below

$${I}_{W} ( X , Y ) = {\sum }_{x ∈ X , y ∈ Y} w ( x , y ) p ( x , y ) {log}_{2} \frac{p ( x , y )}{p ( x ) p ( y )} \qquad ( 12 )$$

where I_{W}(X,Y) is a weighted mutual information metric.

In some implementations, the weight coefficients may use the following selection:

w(x=0, y=0)=user defined value≦1

w(x=0, y=1)=1

w(x=1, y=0)=1

w(x=1, y=1)=1 (13)

Rewriting equation (12) using the above set of coefficients yields:

$${I}_{W} ( X , Y ) = w ( x = 0 , y = 0 ) \frac{C ( x = 0 , y = 0 )}{N} {log}_{2} \frac{c ( x = 0 , y = 0 ) N}{c ( x = 0 ) x ( y = 0 )} + w ( x = 0 , y = 1 ) \frac{C ( x = 0 , y = 1 )}{N} {log}_{2} \frac{C ( x = 0 , y = 1 ) N}{C ( x = 0 ) C ( y = 1 )} + w ( x = 1 , y = 0 ) \frac{C ( x = 1 , y = 0 )}{N} {log}_{2} \frac{C ( x = 1 , y = 0 ) N}{C ( x = 1 ) C ( y = 0 )} + w ( x = 1 , y = 1 ) \frac{C ( x = 1 , y = 1 )}{N} {log}_{2} \frac{C ( x = 1 , y = 1 ) N}{C ( x = 1 ) C ( y = 1 )} \qquad ( 14 )$$

Graphical examples of the impact of user selection of w(x=0, y=0) are provided in a later section.

### 3.6.2 Normalization

Typically, mutual information is measured in bits, so the maximum possible mutual information between two sets of data depends on the amount of data, or in other words, the amount of information in the data set. In some implementations, it may be desirable to use a defined range of mutual information such that all possible relationships can be properly compared regardless of the number of trials for each relationship. One way to achieve this is to normalize the mutual information value by dividing it by a joint entropy.

For example, for cluster maps, a normalized mutual information measure can be defined as

$${I}_{N} ( X ; Y ) = \frac{I ( X ; Y )}{H ( X , Y )} \qquad ( 15 )$$

where the joint entropy is defined by

$$H ( X , Y ) = - {\sum }_{x ∈ X , y ∈ Y} p ( x , y ) {log}_{2} p ( x , y ) \qquad ( 16 )$$

Note that 0≦I_{N}(X;Y)≦1, which puts the metric on a fixed range regardless of the number of trials.

### 3.6.3 Weighted Normalized Mutual Information Metric

One way to define a mutual information measure that is both weighted and normalized can be given below:

$${I}_{N , W} ( X ; Y ) = \frac{{I}_{W} ( X ; Y )}{{H}_{W} ( X , Y )} \qquad ( 17 )$$

In order to preserve the range of 0≦I_{N}(X;Y)≦1, a weighted mutual entropy function can be defined below:

$${H}_{W} ( X , Y ) = - {\sum }_{x ∈ X , y ∈ Y} w ( x , y ) p ( x , y ) {log}_{2} p ( x , y ) \qquad ( 18 )$$

For cluster map applications, equation (18) can be rewritten as:

$${H}_{W} ( X , Y ) = w ( x = 0 , y = 0 ) \frac{C ( x = 0 , y = 0 )}{N} {log}_{2} \frac{c ( x = 0 , y = 0 )}{N} + w ( x = 0 , y = 1 ) \frac{C ( x = 0 , y = 1 )}{N} {log}_{2} \frac{C ( x = 0 , y = 1 )}{N} + w ( x = 1 , y = 0 ) \frac{C ( x = 1 , y = 0 )}{N} {log}_{2} \frac{C ( x = 1 , y = 0 )}{N} + w ( x = 1 , y = 1 ) \frac{C ( x = 1 , y = 1 )}{N} {log}_{2} \frac{C ( x = 1 , y = 1 )}{N} \qquad ( 19 )$$

### 3.6.4 Examples of Weighting Coefficient Use

The following examples show how the use of weighted coefficients in the mutual information metric can, in some implementations, make patterns easier to discern.

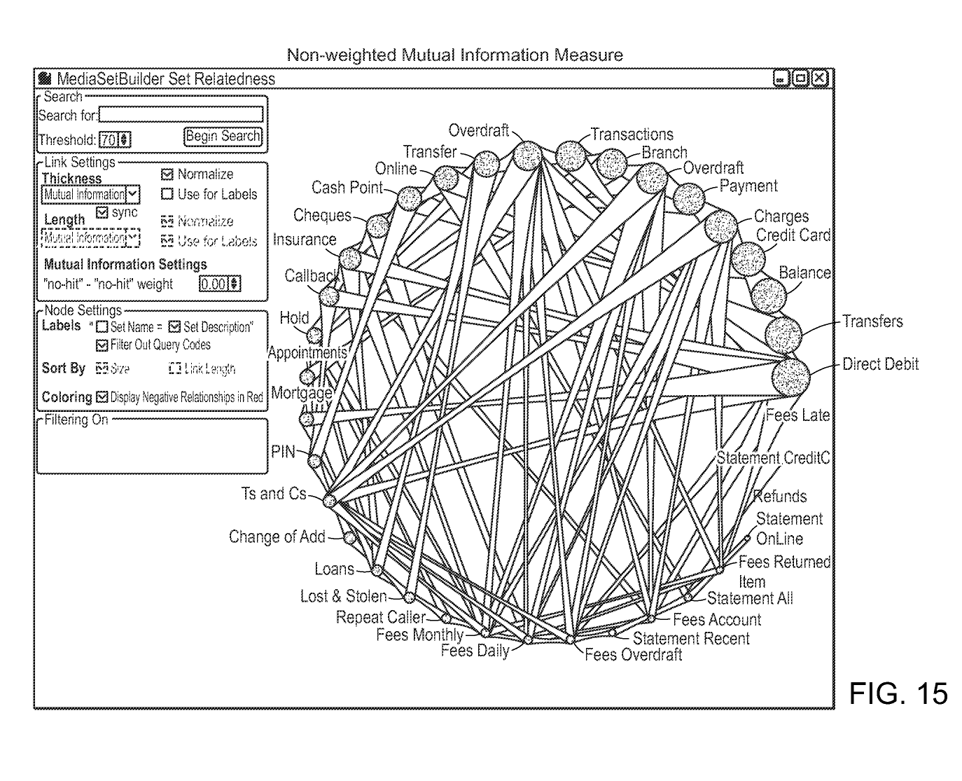

FIG. 15 shows a cluster map with links plotted based on non-weighted mutual information with uniform weight coefficients:

w(x=0, y=0)=1

w(x=0, y=1)=1

w(x=1, y=0)=1

w(x=1, y=1)=1 (20)

In the figure, all combinations of two queries of matching or not matching on a file are weighted equally.

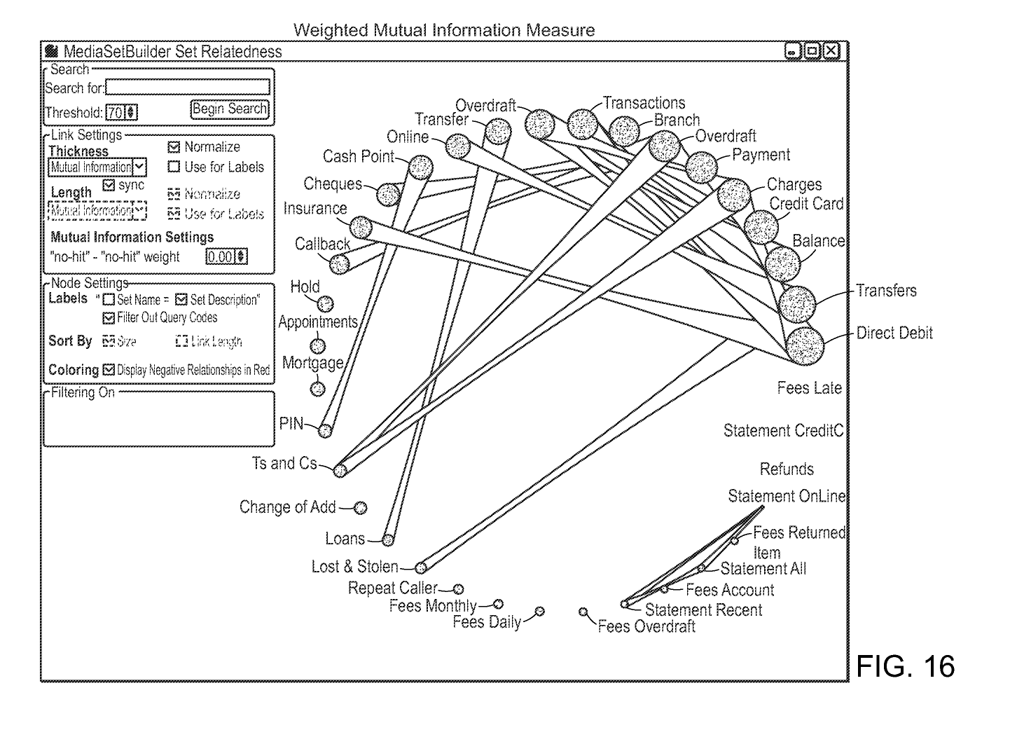

In comparison, FIG. 16 shows a cluster map with links plotted based on weighted mutual information such that the information obtained from both queries missing on a file is completed discounted, as shown below

w(x=0, y=0)=0

w(x=0, y=1)=1

w(x=1, y=0)=1

w(x=1, y=1)=1 (21)

In this figure, all combinations of the two queries of matching/not matching on a file are weighted equally, except for the case in which neither query matches a given file (this information is discarded). In some applications, the strongest relationships are shown in a more visually distinguishable manner in the cluster map of FIG. 16 than in the map of FIG. 15.

### 3.7 Use of Additional Data in Metrics

For some metrics, more complete use could be made of the available data by, for example, counting number of hits per query per file rather than using binary hit/miss data only. For instance, vector-based measures like cosine similarity inherently contain the ability to assign different magnitudes to different dimensions of a vector (e.g., corresponding to the hit counts of a query for each file). In some examples, using binary results in computation of metric values may result in greater computational efficiency and scalability compared to using k-nary results. A further implementation of cluster maps may additionally take hit counts, sequence, and times into consideration.

In some further examples, color coding of links can be implemented to differentiate various types of relationships such as using black and red to represent “positive” and “negative” relationships, respectively.

A positive relationship may be defined, for example, if the number of files with the same results for two queries is greater than the number of files with the opposite results, shown below:

|M_{1,1}|+|M_{0,0}|≧|M_{0,1}|+|M_{1,0}| (22)

Similarly, a negative relationship may be defined, for example, for the opposite condition shown below:

|M_{1,1}|+|M_{0,0}|≦|M_{0,1}|+|M_{1,0}| (23)

For example, a positive relationship may be displayed in black and a negtae

### 4 Other Embodiments

Various alternative embodiments of the system and method described above are possible.

In some applications, a predefined set of queries may be created and automatically run against all incoming audio, and the results may be saved in a “QuickStart Library” that can be used to jump-start a new installation of the system for all users (e.g., different call centers). The library may incorporate queries that pertain to common problems and needs of customers in different domains (e.g., technical support, credit-card customer service). Since customers may not always know at first what they would look for in the data, the presence of these default queries may provide a good starting point, and the ability to see immediately relationships between the default queries may provide direction for creating more focused future queries.

In some applications, the map generator may be used in conjunction with a file classifier that provides automatic audio file classification. The file classifier may be trained based on query results. Selection of features for a classifier (in this case a feature may correspond to a query) is a common task in machine learning, and for this application, it may be preferable to choose features that have as little information in common with each other as possible. Feature selection can be performed automatically or manually. When features are manually selected from a large number of queries that have been applied to a set of training files, the cluster map may serve as an effective tool allowing users interactively to select features (e.g., with low mutual information) before training is conducted.

In some examples, an interactive filter building feature is provided such that one can filter on a logical combination (e.g., logical AND) of queries. This way, queries may be iteratively added to the filter and each successive view would be for a further reduced scope representing a more specifically defined subset of the files.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A method for information visualization, the method comprising:
receiving data characterizing a collection of multimedia content;
processing the data to obtain a set of information objects, each information object being associated with a respective query on at least a portion of the collection of multimedia content; and
generating a visual representation of characteristics of the set of information objects, including:
displaying a plurality of graphical nodes, each graphical node representing a respective one of the information objects;
determining, for each graphical node, a visual property based at least on a characteristic of the corresponding information object;
displaying a plurality of graphical links between the nodes, each graphical link coupling a respective pair of graphical nodes and representing a relationship between the information objects represented by the pair of graphical nodes that are coupled by the link; and
determining, for each link, a visual property based at least on a measure of the relationship represented by the link.

2. The method of claim 1, wherein generating the visual representation further includes obtaining the measure of the relationship between two information objects by computing a relatedness metric of the results of the queries associated with the two information objects.

3. The method of claim 2, wherein the relatedness metric includes one selected from the group of percent overlap, cosine similarity, Dice's coefficient, Jaccard Similarity, Hamming distance, and mutual information.

4. The method of claim 1, wherein the visual property for the graphical nodes includes one selected from the group of shape, size, and color.

5. The method of claim 1, wherein the visual property for the graphical links includes one selected from the group of shape, thickness, length, and color.

6. The method of claim 1, wherein generating the visual representation further includes determining a spatial order in which the plurality of graphical nodes are arranged.

7. The method of claim 1, wherein forming the plurality of graphical links further includes selecting a graphical node of focus and displaying a respective graphical link coupling the node of focus with each one of the remaining nodes.

8. The method of claim 1, wherein generating the visual representation further includes:
accepting a user input; and
changing, for each node, the visual property based at least on the user input.

9. The method of claim 8, wherein generating the graphical user interface further includes:
changing, for each link, the visual property based at least on the user input.

10. The method of claim 8, wherein the user input includes a new query.

11. The method of claim 10, wherein generating the visual representation further includes:
processing the new query to generate a second set of information objects, each set of the second set of information object being associated with a satisfaction of a respective query and the new query.

12. The method of claim 1, wherein the collection of multimedia content includes audio files.

13. The method of claim 12, wherein the data characterizing the collection of multimedia content includes a phonetic index of the audio files.

14. The method of claim 12, wherein processing the data to obtain the set of information objects includes determining each information object based on a result of the respective query against the audio files.

15. The method of claim 14, wherein determining each information object includes using a phonetically based search technique to identify audio files that match the respective query.

16. The method of claim 1, wherein the collection of multimedia content includes video files.

17. A system for information visualization, the system comprising:
a memory device for storing data characterizing a collection of multimedia content;
an input device for accepting a user input;
an output device for displaying a graphical user interface that includes a visual representation of characteristics of a set of information objects associated with the data, each information object being associated with a respective query on at least a portion of the collection of multimedia content;
a processor coupled to the input device, the output device, and the memory device, the processor being configured for processing the user input and the stored data to control the graphical representation of the information objects displayed in the graphical user interface, including:
displaying a plurality of graphical nodes, each graphical node representing a respective one of the information objects;
determining, for each graphical node, a visual property based at least on a characteristic of the corresponding information object;
displaying a plurality of graphical links between the graphical nodes, each graphical link coupling a respective pair of graphical nodes and representing a relationship between the information objects represented by the pair of graphical nodes that are coupled by the graphical link; and
determining, for each graphical link, a visual property based at least on a measure of the relationship represented by the graphical link.

18. The system of claim 17, wherein the processor includes a search tool configured for accepting one or more search terms inputted by the user and for performing a respective query on the multimedia content according to each search term.

19. The system of claim 19, wherein the search tool is further configured for using a phonetically based search technique in performing the query.

20. The system of claim 19, wherein the processor further includes a vector generator configured for generating a set of bit vectors each representing a respective query result.

21. The system of claim 21, wherein at least one bit vector includes N number of binary bits, N being the number of files on which the query is performed.

22. The system of claim 18, wherein the processor includes a mode selector configured for forming a specification of a set of display properties in response to a user selection.

23. The system of claim 23, wherein the set of display properties includes a partially defined spatial arrangement for the plurality of nodes.

24. The system of claim 23, wherein the set of display properties includes a partially defined color coding for the nodes and links.

25. The system of claim 18, wherein the processor further includes a display filter configured for filtering query results based on a user-defined criterion.

26. The system of claim 18, wherein, for each node, the node property represents the volume of a subgroup of multimedia content that satisfies the query.

27. The system of claim 18, wherein, for each link, the link property represents a similarity measure of the query results associated with the two nodes connected by the link.
